(19) United States
(12) Patent Application Publication
(10) Pub. No.: US 2025/0273246 A1
(43) Pub. Date: Aug. 28, 2025

(54) MAGNETIC DISK DEVICE

(71) Applicants: Kabushiki Kaisha Toshiba, Tokyo (JP); Toshiba Electronic Devices & Storage Corporation, Tokyo (JP)

(72) Inventor: Koji SONODA, Yokohama Kanagawa (JP)

(21) Appl. No.: 19/029,506

(22) Filed: Jan. 17, 2025

(30) Foreign Application Priority Data
Feb. 28, 2024 (JP) 2024-028380

(51) Int. Cl. G11B 33/14

(52) U.S. Cl. CPC G11B 33/146

(57) ABSTRACT

A magnetic disk device includes a housing, a disk rotatably provided in the housing, a head provided in the housing and capable of writing and reading information to and from the disk, a voice coil motor provided in the housing and driving the head, and a filter structure provided in the housing and having a porous body including a first porous body with an average pore diameter of 0.4 nm or more and 1.0 nm or less, that is optimized for adsorbing glycol ether.

### CROSS-REFERENCE TO RELATED APPLICATION(S)

This application is based upon and claims the benefit of priority from Japanese Patent Application No. 2024-028380, filed Feb. 28, 2024, the entire contents of which are incorporated herein by reference.

### FIELD

Embodiments described herein relate generally to a magnetic disk device.

### BACKGROUND

A hard disk drive (HDD) includes a magnetic disk that spins at a high speed and a head for reading and writing information from and to the magnetic disk. The presence of large amounts of gas molecules in a housing of the HDD can deteriorate controllability of a distance between the head and the disk, which may shorten the lifetime of the HDD.

### BRIEF DESCRIPTION OF THE DRAWINGS

FIG. 1 is a perspective view illustrating a magnetic disk device according to a first embodiment.

FIG. 2 is a schematic plan view illustrating the magnetic disk device according to the first embodiment.

FIG. 3 is a schematic plan view illustrating a modification of the magnetic disk device according to the first embodiment.

FIG. 4 is a top view illustrating an example of a structure of a first filter.

FIG. 5 is a perspective view illustrating an example of the structure of the first filter.

FIG. 6 is a schematic plan view illustrating an example of the structure of the first filter.

FIG. 7 is a schematic cross-sectional view illustrating a magnetic disk device according to a second embodiment.

FIG. 8 is a diagram illustrating an example of a structure of a second filter.

### DETAILED DESCRIPTION

Embodiments provide a magnetic disk device with excellent performance in removing gas molecules having a predetermined valid diameter.

In general, according to one embodiment, the magnetic disk device includes a housing, a disk rotatably provided in the housing, a head provided in the housing and capable of writing and reading information to and from the disk, a voice coil motor provided in the housing and driving the head, and a filter structure provided in the housing and having a porous body including a first porous body with an average pore diameter of 0.4 nm or more and 1.0 nm or less, that is optimized for adsorbing glycol ether.

Embodiments of the present disclosure will be described below with reference to the drawings.

The drawings are schematic or conceptual, and the relationship between the thickness and width of each part, the ratio of the size between the parts, and the like are not necessarily the same as the actual ones. Even when the same parts are represented, the dimensions and ratios of the same parts may be represented differently from each other depending on the drawings.

In the present specification and each drawing, elements similar to those described earlier with respect to the previously described drawings are denoted with the same reference numerals, and detailed descriptions thereof will be omitted as appropriate.

In description, a direction from a base 11 to a top cover 12 of a housing 10 is referred to as “up” and a direction from the top cover 12 to the base 11 is referred to as “down”. However, the “up” and “down” directions are not limited to the direction of gravity or the direction at the time of implementation of the magnetic disk device.

### First Embodiment

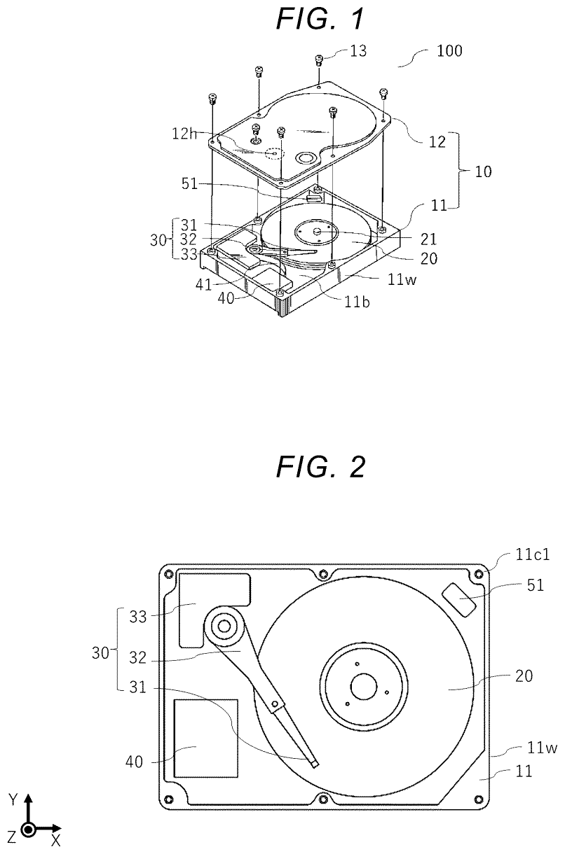

FIG. 1 is a perspective view illustrating a magnetic disk device 100 according to the present embodiment.

The magnetic disk device 100 includes a housing 10, which includes a box-shaped base 11 and a top cover 12. The base includes a bottom surface 11b and a side surface 11w that rises along the edge of the bottom surface 11b and is integrally formed with the bottom surface 11b. The housing 10 is sealed when the top cover 12 is combined with the base 11 by a plurality of joining parts. For example, the joining part may be a screw or the like, or an adhesive or a fit-in mechanism may be utilized. FIG. 1 illustrates an example of joining by a plurality of screws 13. The material of the base 11 or the top cover 12 may be metal including, for example, Al or Fe.

The base 11 is provided with a disk 20 for recording data, a spindle motor 21, and an actuator 30. The spindle motor 21 rotatably holds the disk 20. The actuator 30 includes a head 31 that scans the surface of the disk 20, and reads and writes information. The actuator 30 further includes an arm 32 on which the head 31 is attached and a voice coil motor 33 that controls a position of the arm 32.

The base 11 is provided with a substrate 40. The substrate 40 is electrically connected to the actuator 30 via a flexible printed circuit (FPC) substrate 41. The substrate 40 controls the movement of the head 31 and the voice coil motor 33.

A plurality of disks 20 may be mounted on the spindle motor 21. For example, two, three, or four disks 20 may be mounted. Alternatively, five or more disks 20 may be mounted.

On the base 11, a first filter 51 is provided in the vicinity of the disk 20. The first filter 51 is provided in a position in which at least a portion of the airflow generated by the rotation of the disk 20 passes through. The first filter 51 includes a porous body PM. Details of the porous body PM will be described later.

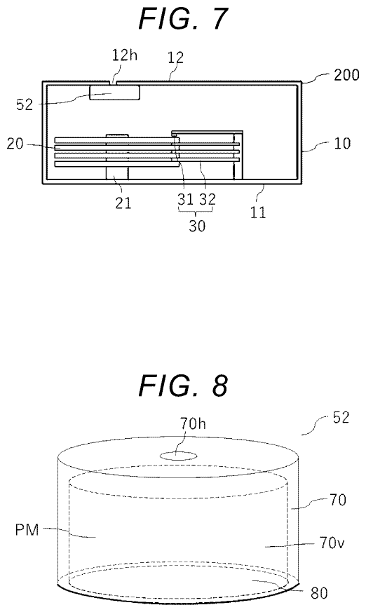

The top cover 12 may be provided with a hole 12h. A second filter 52 may be further provided in the housing 10 in a position corresponding to the hole 12h. The second filter 52 will be described later with reference to FIGS. 7 and 8.

FIG. 2 is a plan view of the magnetic disk device 100 illustrated in FIG. 1.

The base 11 is provided with the first filter 51. FIG. 2 illustrates an example in which the base 11 has four corners. FIGS. 1 and 2 illustrate an example in which the first filter 51 is disposed between a first corner 11c1 of the base 11 and the disk 20. A corner is a portion of the side surface 11w of the base 11 that has a curvature. The first corner 11c1 is one of the corners located opposite to the actuator 30 or the substrate 40 with respect to the disk 20. In an X direction, the disk 20 is located between the first corner 11c1 and the actuator 30 or the substrate 40.

The first filter 51 is provided beside the disk 20. A distance between the first filter 51 and the disk 20 is shorter than a distance between the voice coil motor 33 and the disk 20. The first filter 51 is provided opposite to the voice coil motor 33 relative to the disk 20. In other words, the first filter 51 is located on an opposite side of the disk 20 relative to the voice coil motor 33.

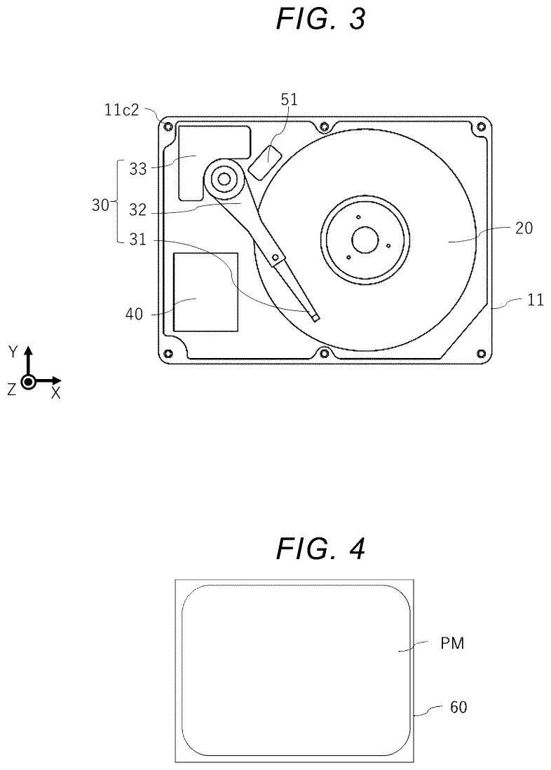

FIG. 3 illustrates an example of providing the first filter 51 between the disk 20 and the actuator 30 as a modification of the magnetic disk device 100 according to the first embodiment. Among the plurality of corners of the base 11, the corner closest to the actuator 30 is referred to as a second corner 11c2. FIG. 3 illustrates an example in which the first filter 51 is provided in the vicinity of the second corner 11c2. Being in the vicinity of a certain corner refers to being closer to the certain corner than to other corners.

The first filter 51 may also be provided, for example, between the disk 20 and the substrate 40. The first filter 51 may be provided in the vicinity of any of the plurality of corners of the base 11. The first filter 51 is provided beside the disk 20. A distance between the first filter 51 and the disk 20 is shorter than a distance between the voice coil motor 33 and the disk 20.

In either case of FIGS. 2 and 3, the first filter 51 is provided beside the disk 20, and airflow generated around the disk 20 passes through at least a portion of the first filter 51.

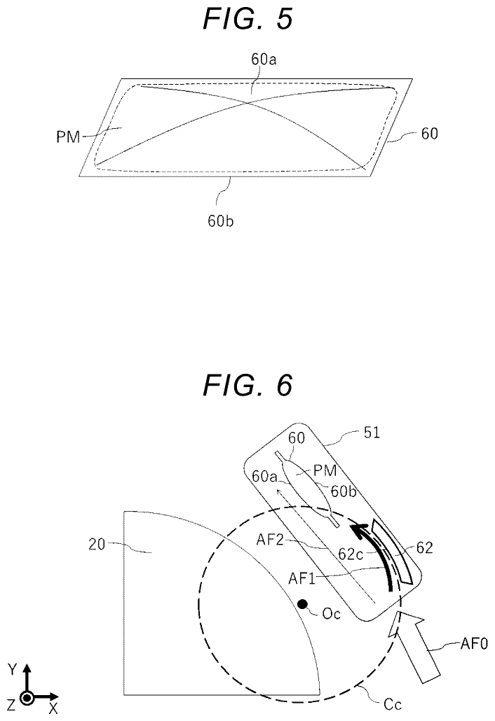

Subsequently, an example of the structure of the first filter 51 will be described with reference to FIGS. 4 and 5.

FIG. 4 is a plan view representing an example of a structure holding the porous body PM provided in the first filter 51.

The first filter 51 includes a surrounding body 60 covering the porous body PM. In FIG. 4, the porous body PM is not exposed and is held to be surrounded by the surrounding body 60. The surrounding body 60 is formed of a breathable material. The surrounding body 60 includes, for example, a non-woven fabric.

FIG. 5 is a perspective view of the surrounding body 60 illustrated in FIG. 4. The surrounding body 60 includes the porous body PM therein, and the peripheral edge is sealed to surround the porous body PM. Airflow in a direction from a first major surface 60a of the surrounding body 60 to a second major surface 60b opposite to the first major surface 60a, or an opposite direction, passes through the porous body PM. The porous body PM adsorbs and removes gas molecules and the like contained in the airflow.

To reduce resistance when airflow passes through the surrounding body 60, the first major surface 60a or the second major surface 60b of the surrounding body 60 is preferably provided in a direction facing the disk 20.

The structure for securing the surrounding body 60 provided in the first filter 51 to the base 11 may be, for example, a structure fitting the first filter 51 into a part having a recess or a structure sandwiching the surrounding body 60.

The first filter 51 is preferably provided with a mechanism that controls the flow path of the airflow. FIG. 6 illustrates a diagram schematically illustrating the surrounding body 60 provided in the first filter 51 and an airflow guide 62. The structure of the first filter 51 provided on the side of the disk 20 is illustrated. The first filter 51 includes the surrounding body 60 including the porous body PM and the airflow guide 62 provided downstream of the airflow generated by the rotation of the disk 20, configured to guide the airflow caused by rotation of the disk 20. FIG. 6 illustrates an example in which the first major surface 60a of the surrounding body 60 is provided in a direction facing the disk 20. At least a portion of the airflow guide 62 is provided farther from the disk 20 than the surrounding body 60.

The airflow guide 62 includes a curved surface 62c. At least a portion of the curved surface 62c is provided along an arc. Here, the arc may be a circular arc or an elliptical arc. For example, the arc is provided along a curvature circle Cc having a predetermined radius of curvature. A curvature center Oc of the curvature circle Ce is located in the same direction as the direction in which the disk 20 is provided relative to the airflow guide 62. A curvature center Oc is located near an edge of the disk 20 in a direction that is towards a center of the disk 20. In other words, the curved surface 62c is bent in the same direction as the circular arc, which is the shape of the edge of the circular disk 20.

The porous body PM provided in the first filter 51 includes at least a first porous body. Preferably, an average pore diameter of the first porous body is less than an average pore diameter of activated carbon or silica gel. Here, the average pore diameter is measured and averaged for at least two or more pores. The average pore diameter may also be a median or a most frequent value of diameters measured for at least two or more pores. The average diameter of the pores of activated carbon or silica gel is, for example, greater than 1.0 nm.

The first porous body has pores with an average diameter of, for example, 0.4 nm or more and 1.0 nm or less. To adsorb a gas molecule with a valid diameter of, for example, 0.4 to 0.7 nm, the average diameter of the pores is preferably 0.7 nm or more and 1.0 nm or less. Here, the valid diameter of gas molecules, also known in the art as effective molecular diameter of gas molecules or collision diameter of gas molecules, corresponds to a diameter of the gas molecules assuming a spherical shape that collide with each other, for example.

The first porous body is a porous body including, for example, zeolite. Hereinafter, when referred to as zeolite, synthetic zeolite is included. The framework of a zeolite composition is provided as a three-letter designation (framework type code) by the International Zeolite Association. The first porous body is, for example, a zeolite belonging to the framework type code FAU. The first porous body is, for example, an X-type zeolite. The first porous body is, for example, a 13X-type zeolite.

The first filter 51 may also include activated carbon in addition to the first porous body. The first filter may include a silica gel.

The first filter 51 may include a second porous body P2 in addition to the first porous body. The second porous body has pores with an average diameter of, for example, 0.1 nm or more and 0.4 nm or less. Preferably, the average diameter may be 0.2 nm or more and 0.4 nm or less. The second porous body is a porous body including, for example, zeolite. The second porous body is, for example, a zeolite belonging to the framework type code LTA. The second porous body is, for example, an A-type zeolite. The second porous body is, for example, a 3A-type zeolite.

The operation of the magnetic disk device 100 will be described.

The disk 20 is rotated by the spindle motor 21. Based on the signal transmitted from the substrate 40, the voice coil motor 33 is driven to control the position of the head 31 relative to the rotating disk 20. The magnetic disk device 100 operates by writing or reading magnetic information at various positions on the disk 20 while changing the positions of the head 31.

In response to the rotation of the disk 20, air flows around the disk 20. Here, air is not limited to the composition of gases in the atmosphere, but may include a variety of gas molecules. The flow of air on the surface of the disk 20 controls the spacing between the disk 20 and the head 31.

Meanwhile, airflow on the side of the disk 20 forms a circular flow. The first filter 51 is located beside the disk 20, and at least a portion of the air flowing around the disk 20 passes through the first filter 51. As air passes through the first filter 51, gas molecules having a valid diameter of a predetermined size are adsorbed by the porous body PM.

An example of the flow path of the airflow through the first filter 51 will be described with reference to FIG. 6. As the disk 20 rotates, airflow AF0 flows into the first filter 51. At least a portion of the airflow AF0 flows alongside the airflow guide 62 to form airflow AF1. At least a portion of the airflow AF0, illustrated as airflow AF2, may also flow on the side of the first major surface 60a of the surrounding body 60.

The direction of the airflow AF1 changes along the curved surface 62c of the airflow guide 62. The angle at which the airflow AF1 impinges on the second major surface 60b of the surrounding body 60 is controlled by the shape of the curved surface 62c of the airflow guide 62. As the airflow AF1 is passed through the surrounding body 60 in the direction from the second major surface 60b to the first major surface 60a, the porous body PM provided in the surrounding body 60 adsorbs gas molecules contained in the airflow.

Gas molecules with a valid diameter of 1.0 nm or less are known to be difficult to remove in activated carbon and silica gel due to the large average diameter of the pores. The higher the viscosity of the gas molecule, the more difficult it is to remove the gas molecule adhered to the disk or the like. The higher the boiling point of the gas molecule and the harder it is to volatilize, the more difficult it is to separate the gas molecule by heat. When only activated carbon or silica gel is used, there is a risk that the lifetime of the magnetic disk device would be reduced due to gas molecules with high viscosity and boiling point with the valid diameter of 1.0 nm or less.

Gas molecules with a valid diameter of 1.0 nm or less include, for example, glycol ether or glycol ester. Glycol ether and glycol ester have a greater molecular weight and intermolecular force than, for example, ethanol. It has been found that glycol ether and glycol ester have higher viscosities and boiling points than ethanol and the like, making glycol ether and glycol ester more difficult to remove when attached to the disk or the like.

Glycol ether includes, for example, ethylene glycol monomethyl ether (2-methoxyethanol), diethylene glycol monomethyl ether (2-(2-methoxyethoxy)ethanol), ethylene glycol monoethyl ether (2-ethoxyethanol), diethylene glycol monoethyl ether (2-(2-ethoxyethoxy)ethanol), ethylene glycol monobutyl ether (2-butoxyethanol), diethylene glycol monobutyl ether (2-(2-butoxyethoxy)ethanol), propylene glycol monomethyl ether (1-methoxy-2-propanol), or dipropylene glycol monomethyl ether (2-methoxymethylethoxy)propanol). Glycol ether includes molecules having a valid diameter of 0.4 nm or more and 0.7 nm or less.

Glycol ether may include molecules having a boiling point of 120° C. or more and 240° C. or less. Glycol ether with a higher boiling point than alcohol such as ethanol is included.

Glycol ether may include molecules with a viscosity of 4 cP or more and 8 cP or less at ambient temperature and pressure. Glycol ether with a higher viscosity than alcohol such as ethanol is included.

Glycol ester also includes, for example, ethylene glycol monoethyl ether acetate, diethylene glycol monoethyl ether acetate, ethylene glycol monobutyl ether acetate, diethylene glycol monobutyl ether acetate, propylene glycol monomethyl ether acetate, or dipropylene glycol monomethyl ether acetate. Glycol ester includes molecules having a valid diameter of 0.4 nm or more and 0.7 nm or less.

Glycol ester may include molecules having a boiling point of 120° C. or more and 240° C. or less. Glycol ester with a higher boiling point than alcohol such as ethanol is included.

Glycol ester may include molecules having a viscosity of 4 cP or more and 8 cP or less at ambient temperature and pressure. Glycol ester with a higher viscosity than alcohol such as ethanol is included.

According to the magnetic disk device 100 according to the present embodiment, the porous body PM including the first porous body provided in the first filter 51 has excellent performance in adsorbing predetermined contaminants as described later and is capable of extending the lifetime of the magnetic disk device. The first porous body has, for example, pores having an average diameter of 0.4 nm or more and 1.0 nm or less and performs excellently in adsorbing and removing gas molecules having a valid diameter of 1.0 nm or less. For example, the performance in removing glycol ether and glycol ester is excellent. Contamination of the inside of the housing 10 can be reduced and the lifetime of the magnetic disk device 100 can be extended. The average pore diameter of the first porous body is optimized for adsorbing, for example, glycol ether and glycol ester. The upper limit of the the average pore diameter of the first porous body is, for example, 1.0 nm, and such first porous body effectively adsorbs glycol ether and glycol ester having a valid diameter of 1.0 nm or less.

Glycol ether or glycol ester with a higher boiling point and viscosity than alcohol such as ethanol are easy to adhere to and difficult to remove from the HDD, which may shorten the lifetime of the HDD. According to the magnetic disk device 100 according to the present embodiment, the performance in removing gas molecules having a valid diameter of 1.0 nm or less, including glycol ether and glycol ester, is excellent, and the lifetime of the magnetic disk device 100 can be extended.

It is preferable that the porous body PM provided in the first filter 51 includes activated carbon in addition to the first porous body. Activated carbon can adsorb molecules of a size that cannot be adsorbed by the first porous body, for example, molecules having a valid diameter greater than 1.0 nm. Accordingly, a wider range of contaminants can be removed to extend the lifetime of the magnetic disk device 100. Activated carbon may be substituted, for example, with silica gel. Hereinafter, porous body with relatively large pore size, such as activated carbon or silica gel, may be referred to as a third porous body.

Since the average diameter of the pores of the first porous body is 1.0 nm or less, the efficiency of adsorption can be improved for small gas molecules that are difficult for activated carbon or the like to adsorb as the main target of the first porous body. By inhibiting gas molecules of a size that can be adsorbed by activated carbon and the like from occupying the adsorption site of the first porous body, the first porous body can adsorb more small gas molecules that cannot be adsorbed by activated carbon and the like. Accordingly, gas molecules having a valid diameter of 0.4 nm or more and 0.7 nm or less can be efficiently adsorbed compared to the case where the average diameter of the pores of the first porous body is greater.

The porous body PM provided in the first filter 51 may further include a second porous body. The second porous body includes, for example, pores having an average diameter of 0.2 nm or more and 0.4 nm or less and has better performance in adsorbing water molecules than the first porous body. Accordingly, the humidity in the housing 10 can be further reduced. The second porous body is superior in adsorbing inorganic molecules such as water molecules, while the first porous body is superior in adsorbing organic molecules such as glycol ethers (small molecules). The average pore diameter of the second porous body is optimized for adsorbing, for example, water molecules.

By providing the first filter 51 on the side of the disk 20, gas molecules contained in the airflow generated on the side of the disk 20 as the disk 20 rotates can be efficiently adsorbed. When the spindle motor 21 that rotates the disk 20 is a source of gas molecules, the first filter 51 can be provided near the source to efficiently remove the gas molecules.

When the source of the gas molecule is identified within the housing 10, the first filter 51 can be provided near the source of the gas molecule, thereby efficiently removing the gas molecule.

When the first main surface 60a or the second main surface 60b of the surrounding body 60 provided in the first filter 51 faces the disk 20, resistance when airflow passes through can be reduced and the influence on the rotation of the disk 20 can be reduced. By reducing the air resistance by the surrounding body 60, a decrease in the rotational speed of the disk 20 can be reduced.

When the first main surface 60a or the second main surface 60b of the surrounding body 60 faces the disk 20, the flow path through the porous body PM can be elongated and the efficiency of removing the gas molecules can be improved compared to when the airflow flows at a right angle to the first main surface 60a or the second main surface 60b.

The first filter 51 includes the airflow guide 62 illustrated in FIG. 6, for example, to control the airflow AF1 to flow at an angle less than 90 degrees to the second major surface 60b of the surrounding body 60. The angle of the airflow AF1 flowing into the second major surface 60b can be controlled by the airflow guide 62. The shallower the angle to the second main surface 60b, the longer the airflow AF1 can pass through the surrounding body 60. Accordingly, the efficiency of removing the gas molecules by the porous body PM provided in the surrounding body 60 can be further enhanced.

The curvature center Oc of the curved surface 62c of the airflow guide 62 is located in the same direction as the direction in which the disk 20 is provided with respect to the airflow guide 62, and the airflow AF1 is directed toward the second main surface 60b while gradually changing the direction thereof, thereby reducing air resistance by the airflow guide 62.

### Second Embodiment

FIG. 7 is a schematic cross-sectional view illustrating a magnetic disk device 200 according to the second embodiment.

The magnetic disk device 200 includes the disk 20, the spindle motor 21, and the actuator 30 in the housing 10. The actuator 30 includes the head 31 and the arm 32.

The top cover 12 of the housing 10 is provided with the hole 12h. The hole 12h is not limited to being circular and may be rectangular, elliptical, oval, or the like. The hole 12h is not limited to being provided above the disk 20 and may be located above the substrate 40 as also illustrated in FIG. 1, which illustrates the semiconductor device 1 according to the first embodiment, or above the actuator 30.

The inner wall of the housing 10 is provided with a second filter 52 in the area covering the hole 12h. The upper surface of the second filter 52 (with the surface facing the base 11 as the lower surface) is in contact with the inner wall of the housing 10. The second filter 52 is provided with the porous body PM including a first porous body. The porous body PM may further include at least one among activated carbon, silica gel, or a second porous body.

Next, FIG. 8 is a schematic diagram illustrating an example of the structure of the second filter 52. The second filter 52 includes a frame 70 including a cavity 70v, the porous body PM provided in the cavity 70v of the frame 70, and a ventilation membrane 80 provided on a lower surface of the frame 70 and an opening of the cavity 70v.

The frame 70 includes a hole 70h on the upper surface. The hole 70h is provided in a position corresponding to the hole 12h illustrated in FIG. 7. The hole 70h may be similar in shape to the hole 12h. The hole 70h may also be the same shape as the hole 12h.

The porous body PM including the first porous body is covered with the frame 70 on the upper side and on the lateral side, and at least a portion of the lower side thereof is covered with the ventilation membrane 80.

The second filter 52 may further include a mechanism that controls airflow between the hole 70h and the porous body PM.

The frame 70 includes, for example, plastic resin. The ventilation membrane 80 is a breathable membrane and includes, for example, a non-woven fabric. The porous body PM provided in the second filter 52 may include at least one among activated carbon, silica gel, or a second porous body in addition to the first porous body.

According to the magnetic disk device 200 according to the present embodiment, a predetermined gas can be sealed in the housing 10 and gas molecules having a valid diameter of 1.0 nm or less can be efficiently removed. For example, when He is sealed in the housing 10, the inside of the housing 10 is mainly filled by He because He is sufficiently smaller than the average diameter of the pores of the first porous body so that He can pass through without adsorption. On the other hand, the first porous body can remove gas molecules having a larger valid diameter than He, for example, glycol ether and glycol ester. Accordingly, the concentration of gas molecules having a high viscosity and boiling point within the housing 10 can be reduced and the lifetime of the HDD can be extended.

First, the second filter 52 and the hole 12h are described. As an example, the case where He is sealed in the housing will be described. In general, by sealing He, the air resistance due to the gas molecules in the housing can be reduced, and the vertical movement of the head can be reduced.

When He is injected from the outside of the housing 10 to the inside of the housing 10 through the hole 12h, there is a risk that different gas molecules will mix in at the same time. By providing the second filter 52 having the porous body PM including the first porous body in the flow path of the gas molecules to be injected from the outside of the housing 10 to the inside of the housing 10, it is possible to reduce the incorporation of different gas molecules during He encapsulation.

The first porous body includes, for example, pores having an average diameter of 0.4 nm or more and 1.0 nm or less, as in the case of the first embodiment. Accordingly, the performance in adsorbing gas molecules having a valid diameter of 1.0 nm or less is excellent. When the average diameter of the pores is 0.7 nm or more and 1.0 nm or less, the incorporation of gas molecules having a valid diameter of 0.4 nm to about 0.7 nm can be further reduced. For example, incorporation of glycol ether and glycol ester can be reduced.

Even when air is present in the housing 10, gas molecules adsorbed to the porous body PM of the second filter 52 are discharged from the hole 12h to the outside of the housing 10 via the hole 70h, and the second filter 52 can further adsorb contaminants.

Above, an example in which the second filter 52 is provided to contact the top cover 12 was described. The position in which the second filter 52 is provided is not limited to the position in contact with the top cover 12 but can be provided in various positions in contact with the inner wall of the housing 10. Note that the opening of the cavity 70v and the ventilation membrane 80 are provided on a surface opposite to the surface in contact with the inner wall of the housing 10.

Of course, a magnetic disk device may include both the first filter 51 described in the first embodiment and the second filter 52 described in the present embodiment. By including both the first filter 51 and the second filter 52, the performance of removing the predetermined gas molecules can be further improved.

According to the semiconductor device of at least one of the first and second embodiments described above, by having a filter structure including the first filter 51 or the second filter 52 having the porous body PM including the first porous body, it is possible to provide a magnetic disk device having excellent performance in removing molecules having a valid diameter of 1.0 nm or less and high viscosity and boiling point, such as glycol ether, and glycol ester. Thereby, the lifetime of the magnetic disk device can be extended.

Above, embodiments have been described with reference to specific examples. However, the embodiments are not limited to the specific examples. That is, embodiments in which a person skilled in the art has made appropriate changes in design of the specific examples are also encompassed within the scope of the embodiments as long as the embodiments have the features of the embodiments. Each element of each of the foregoing specific examples and arrangement, material, conditions, shape, diameter, and the like thereof are not limited to those illustrated and can be changed as appropriate.

Each element provided in each of the foregoing embodiments can be combined to the extent technically possible, and combinations thereof are also encompassed within the scope of the embodiments to the extent as long as the features of the embodiments are included. Within the scope of the ideas of the embodiments, it is understood that a person skilled in the art can conceive of various changes and modifications, and such changes and modifications also belong to the scope of the embodiments.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A magnetic disk device comprising:
a housing;
a disk rotatably provided in the housing;
a head provided in the housing and capable of writing and reading information to and from the disk; and
a filter structure provided in the housing and including a first porous body with an average pore diameter of 0.4 nm or more and 1.0 nm or less, that is optimized for adsorbing glycol ether.

2. The magnetic disk device according to claim 1, wherein the filter structure further includes a second porous body having an average pore diameter less than the average pore diameter of the first porous body.

3. The magnetic disk device according to claim 2, wherein the second porous body has the average pore diameter of 0.2 nm or more and less than 0.4 nm.

4. The magnetic disk device according to claim 3, wherein the average pore diameter of the second porous body is optimized for adsorbing water molecules.

5. The magnetic disk device according to claim 1, wherein the filter structure further includes a third porous body having an average pore diameter greater than the average pore diameter of the first porous body.

6. The magnetic disk device according to claim 5, wherein the third porous body includes activated carbon or silica gel.

7. The magnetic disk device according to claim 1, wherein the filter structure further includes:
a second porous body having an average pore diameter less than the average pore diameter of the first porous body; and
a third porous body having an average pore diameter greater than the average pore diameter of the first porous body.

8. The magnetic disk device according to claim 1, wherein
the filter structure has an upper surface in contact with an inner wall of the housing and further includes:
a frame including a cavity; and
a ventilation membrane provided on a lower surface of the frame and covering an opening of the cavity, and
the first porous body is provided in the cavity of the frame above the ventilation membrane.

9. The magnetic disk device according to claim 1, wherein the first porous body includes pores adsorbing a glycol ether with a valid diameter of 0.4 nm or more and 0.7 nm or less.

10. The magnetic disk device according to claim 1, wherein
the first porous body includes pores adsorbing a glycol ether including at least one type of molecule selected from ethylene glycol monomethyl ether, diethylene glycol monomethyl ether, ethylene glycol monoethyl ether, diethylene glycol monoethyl ether, ethylene glycol monobutyl ether, diethylene glycol monobutyl ether, diethylene glycol monobutyl ether, propylene glycol monomethyl ether, or dipropylene glycol monomethyl ether.

11. A magnetic disk device comprising:
a housing;
a disk rotatably provided in the housing;
a head provided in the housing and capable of writing and reading information to and from the disk; and
a filter structure provided in the housing and including a first porous body and a second porous body having an average pore diameter less than the average pore diameter of the first porous body, the filter structure including pores with an average pore diameter of 0.4 nm or more and 1.0 nm or less.

12. The magnetic disk device according to claim 11, wherein the first porous body has an average pore diameter of 0.4 nm or more and 1.0 nm or less.

13. The magnetic disk device according to claim 11, wherein the filter structure further includes a third porous body having an average pore diameter greater than the average pore diameter of the first porous body.

14. The magnetic disk device according to claim 11, wherein the second porous body has an average pore diameter of 0.4 nm or more and 1.0 nm or less.

15. A magnetic disk device comprising:
a housing;
a disk rotatably provided in the housing;
a head provided in the housing and capable of writing and reading information to and from the disk;
a voice coil motor provided in the housing and driving the head; and
a filter structure provided in the housing and located closer to the disk than to voice coil motor.

16. The magnetic disk device according to claim 15, wherein the filter structure is located between the voice coil motor and an edge of the disk.

17. The magnetic disk device according to claim 15, wherein the filter structure is located on an opposite side of the disk relative to the voice coil motor.

18. The magnetic disk device according to claim 15, wherein the filter structure further includes an airflow guide configured to guide an airflow caused by rotation of the disk.

19. The magnetic disk device according to claim 18, wherein the airflow guide is provided upstream of the airflow flowing into the filter structure.

20. The magnetic disk device according to claim 18. wherein the airflow guide further includes a curved surface having a curvature center located near an edge of the disk in a direction that is towards a center of the disk.
